(19) United States
(12) Patent Application Publication
(10) Pub. No.: US 2006/0213732 A1
(43) Pub. Date: Sep. 28, 2006

(54) Brake rotor with rotational degrees of freedom

(75) Inventors: Gary Walter Leevy, Farmington Hills, MI (US); Neil Alan Wasylewski, Farmington Hills, MI (US); Douglas Charles Myers, Canton, MI (US); Karl-Heinz Simons, Merzenich (DE); Gunnar Robert Ross, Livonia, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/089,214

(22) Filed: Mar. 23, 2005

(51) Int. Cl. F16D 65/12

(52) U.S. Cl. 188/218 XL

(57) ABSTRACT

A two-piece brake rotor assembly includes a hub portion and a brake rotor portion. The brake rotor portion is mounted onto the hub portion and one of the brake rotor portion and the hub portion includes extending features and the other one of the brake rotor portion and the hub portion includes receiving features. The extending features engage the receiving features to secure the brake rotor portion onto the hub portion. The engagement of the extending features and the receiving features is adapted to allow rotational movement of the rotor portion relative to the hub portion about a tangential axis at the interface between the extending portions and receiving portions.

### TECHNICAL FIELD

The present invention relates generally to a brake rotor assembly for an automotive vehicle.

### BACKGROUND

An important issue with current brake rotor/hub designs involves distortion of the braking surface due to bolt-up variations during wheel assembly. This distortion, which is quantified by lateral run-out (LRO), is caused by many factors including machining and assembly tolerances, presence of dirt or other foreign matter between mating surfaces, or due to the introduction of non-uniform or uneven clamping forces.

Lateral run-out of the braking surface causes significantly increased wear of the brake rotors and friction material, therefore, there exists a need for a brake rotor assembly wherein the brake rotor is attached to the hub portion in such a way that “on-vehicle”, or wheel induced, lateral run-out of the brake rotor is reduced, thereby increasing the efficiency and life of the brake rotor assembly.

### BRIEF SUMMARY

The present invention provides a two-piece brake rotor assembly that includes a hub portion and a brake rotor portion. The brake rotor portion is mounted onto the hub portion. In an aspect of the present application, one of the brake rotor portion and the hub portion includes extending features and the other one of the brake rotor portion and the hub portion includes receiving features. The extending features engage the receiving features to secure the brake rotor portion onto the hub portion. The engagement of the extending features and the receiving features is adapted to allow rotational movement of the rotor portion relative to the hub portion about a tangential axis at the interface between the extending portions and receiving portions.

In another aspect of the present application, the extending features include a continuous annular ridge and the receiving features include a continuous annular channel. The continuous annular ridge may include indents spaced circumferentially thereon to mechanically interlock the brake rotor portion and the hub portion to prevent circumferential movement of the brake rotor portion relative to the hub portion. Alternatively, the extending features may include a plurality of spokes and the receiving features may include a plurality of pockets formed therein such that distal ends of one of the spokes is received within each of the pockets.

In yet another aspect of the present application, the extending features include a convex, arcuate shaped distal end and the receiving features include a concave arcuate shaped pocket, the extending features extend into the receiving features such that only the arcuate shaped portion of the extending portions extends within the arcuate shaped pocket, thereby allowing rotational movement of the extending features relative to the receiving features and therefore, allowing rotational movement of the hub portion relative to the brake rotor portion.

In still another aspect of the present application, the extending features and the receiving features define a ball stud engagement, wherein the extending features have a ball formed at a distal end thereof and the receiving features define a corresponding pocket to receive the ball formed at the distal end of the extending features and allow rotational movement of the brake rotor portion relative to the hub portion. The pocket of the receiving feature may includes a flared opening to provide clearance to allow the extending portion to rotate relative to the pocket.

In yet another aspect of the present application, there is radial translation permitted between the extending features and the receiving features to allow limited radial movement of the brake rotor portion relative to the hub portion, thereby providing both limited radial movement and rotational movement of the brake rotor portion relative to the hub portion.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a perspective view of a brake rotor assembly according to the teachings of the present application;

FIG. 2 is a top view of the brake rotor assembly shown in FIG. 1;

FIG. 3 is a cross sectional view taken along lines 3-3 of FIG. 2, wherein the extending portions extend from the hub portion of the brake rotor assembly;

FIG. 4 is a cross sectional view similar to FIG. 3 wherein the extending portions extend from the brake rotor portion of the brake rotor assembly;

FIG. 5 is a perspective view of an alternative embodiment wherein the extending portions comprise an annular ridge;

FIG. 6 is a sectional view taken along lines 6-6 of FIG. 5 wherein the annular ridge extends from the outer diameter of the hub portion;

FIG. 7 is a sectional view similar to FIG. 6 wherein the annular ridge extends from the inner diameter of the brake rotor portion;

FIG. 8 is a top view of a brake rotor assembly similar to that shown in FIG. 5 wherein the annular ridge includes indents formed therein;

FIG. 9 is a sectional view taken along line 9-9 of FIG. 8;

FIG. 10 is an exploded view of a portion of FIG. 4 wherein only an arcuate shaped distal end of the extending feature engages the pocket of the receiving feature;

FIG. 10a is a view similar to FIG. 10 wherein part of a straight segment of the extending feature engages the pocket of the receiving feature;

FIG. 11 is a top view of a brake rotor assembly wherein the extending features and the receiving features define a ball stud engagement;

FIG. 12 is a cross sectional view taken along lines 12-12 of FIG. 11 wherein the extending features extend from the outer diameter of the hub portion;

FIG. 13 is a cross sectional view similar to FIG. 12 wherein the extending features extend from the inner diameter of the brake rotor portion;

FIG. 14 is an enlarged view of a portion of FIG. 12;

FIG. 15 is an enlarged view similar to FIG. 14 wherein the pocket has a flared opening; and

FIG. 16 is an enlarged view similar to FIG. 15 wherein there is a radial clearance between the pocket and the ball portion of the extending features.

### DETAILED DESCRIPTION

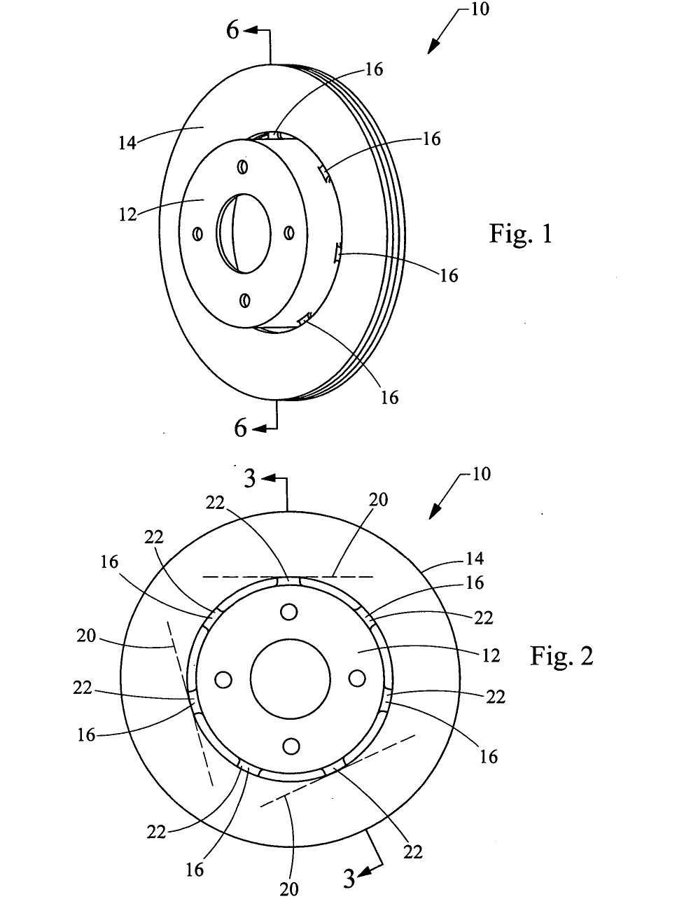

Referring to FIG. 1 a brake rotor assembly in accordance with the teachings of the present application is shown generally at 10. The brake rotor assembly 10 is a two piece assembly having a hub portion 12 and a brake rotor portion 14. The brake rotor portion 14 is mounted onto the hub portion 12 and interlocked to resist movement in response to torque generated during braking, to comprise the brake rotor assembly 10.

To prevent distortion of the brake rotor portion 14 due to bolt-up variations during assembly, the brake rotor portion 14 and the hub portion 12 are attached to one another such that rotational movement of the brake rotor portion 14 relative to the hub portion 12 is allowed in the cross-sectional plane about a tangential axis 20 as shown in FIG. 2.

One of the brake rotor portion 14 and the hub portion 12 includes extending features 16. The other one of the brake rotor portion 14 and the hub portion 12 includes receiving features 18. The extending features 16 engage the receiving features 18 to secure the brake rotor portion 14 onto the hub portion 12. The engagement of the extending features 16 and the receiving features 18 is adapted to allow rotational movement of the brake rotor portion 14 relative to the hub portion 12 about a tangential axis 20 at the interface between the extending portions 16 and receiving portions 18.

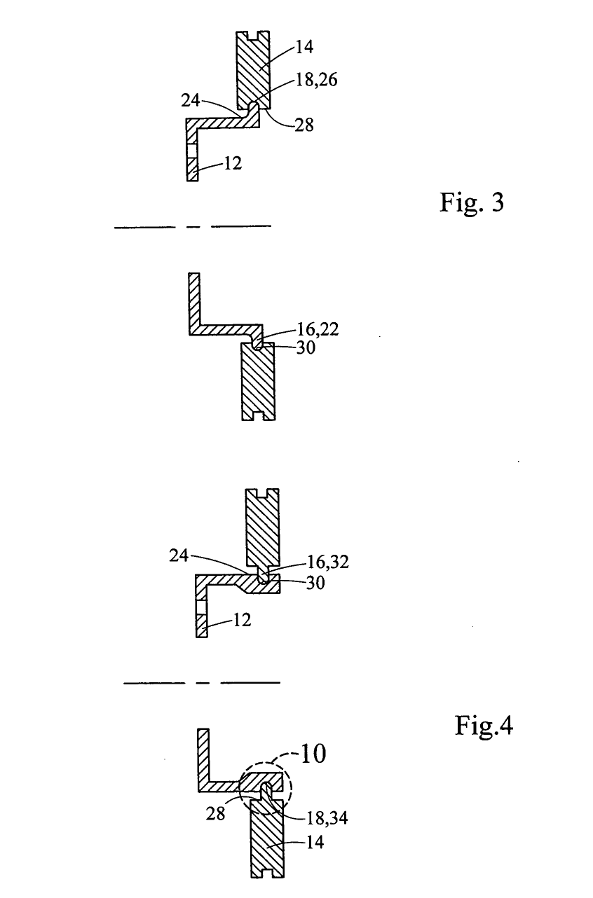

Referring to FIGS. 1, 2, and 3, in one embodiment, the extending features 16 comprise a plurality of spokes 22 extending radially outward from an outer diameter 24 of the hub portion 12. Correspondingly, the receiving features 18 comprise a plurality of pockets 26 formed within an inner diameter 28 of the brake rotor portion 14. The distal ends 30 of one of the spokes 22 are received within each of the pockets 26.

Alternatively, the extending features 16 can include a plurality of spokes 32 extending radially inward from the inner diameter 28 of the brake rotor portion 14 and the receiving features 18 comprise a plurality of pockets 34 formed within the outer diameter 24 of the hub portion 12, as shown in FIG. 4.

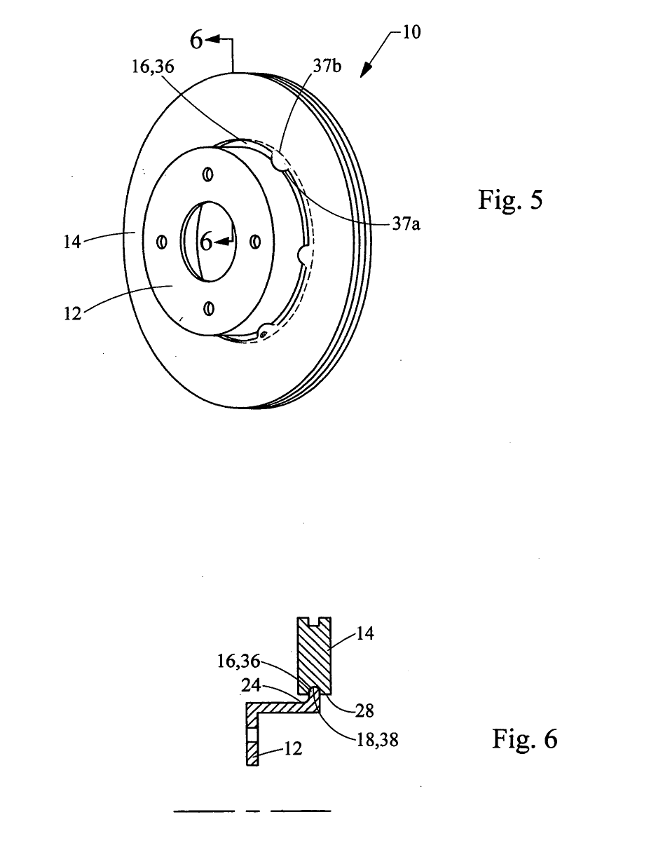

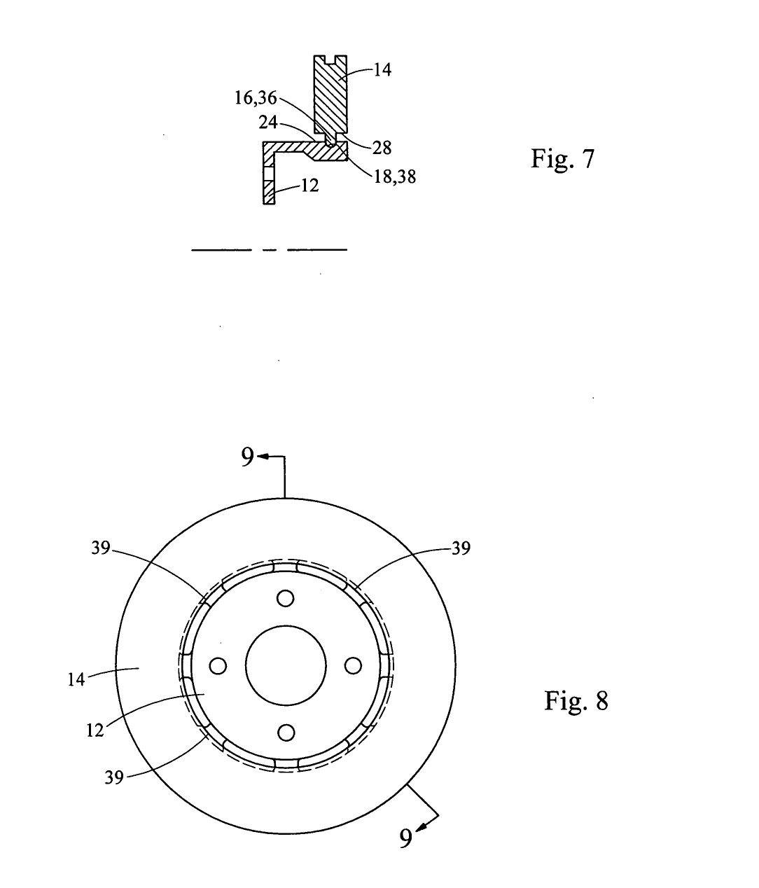

In another embodiment, the extending features 16 comprise an annular ridge 36 extending radially outward from the outer diameter 24 of the hub portion 12 and having a plurality of circumferentially spaced radial discontinuities 37a. The receiving features 18 include an annular channel 38 formed within the inner diameter 28 of the brake rotor portion 14, as shown in FIGS. 5 and 6. The annular channel includes a corresponding plurality of circumferentially spaced radial discontinuities 37b that engage the discontinuities 37a formed in the annular ridge 36 such that braking torque can be transferred between the hub portion 12 and the brake rotor portion 14. Referring to FIG. 7, alternately, the annular ridge 36 can extend radially inward from the inner diameter 28 of the brake rotor portion 14 and the annular channel 38 is formed within the outer diameter 24 of the hub portion 12.

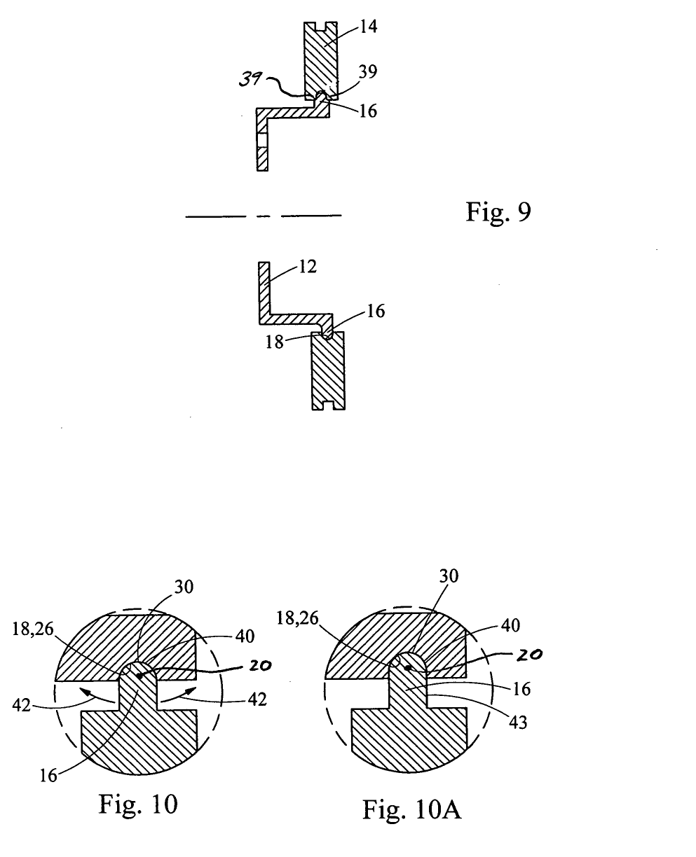

The annular ridge 36 may also include axial indents 39 formed therein and spaced circumferentially thereabout to keep the brake rotor portion 14 circumferentially locked to the hub portion 12, as shown in FIG. 8 and 9.

Referring to FIG. 10, the extending features 16 include a convex, arcuate shaped distal end 30 and the receiving features 18 include a concave arcuate shaped pocket 26. The extending features 16 extend into the receiving features 18 such that only the arcuate shaped portion 40 of the extending features 16 extends within the arcuate shaped pocket 26. Thus, the extending features 16 are allowed to rotate relative to the pockets 26 and the hub portion 14 as indicated by arrows 42. Alternatively, the extending features 16 may extend into the receiving features 18 to a depth wherein the entire arcuate shaped distal end 30 as well as a portion of a straight segment 43 of the extending feature 16, as shown in FIG. 10a. By allowing a portion of the straight segment 43 to engage the pocket 26, rotational movement of the hub portion 12 and the rotor portion 14 is allowed, but there will be some resistance due to the engagement of the straight segment 43 with the pocket 26.

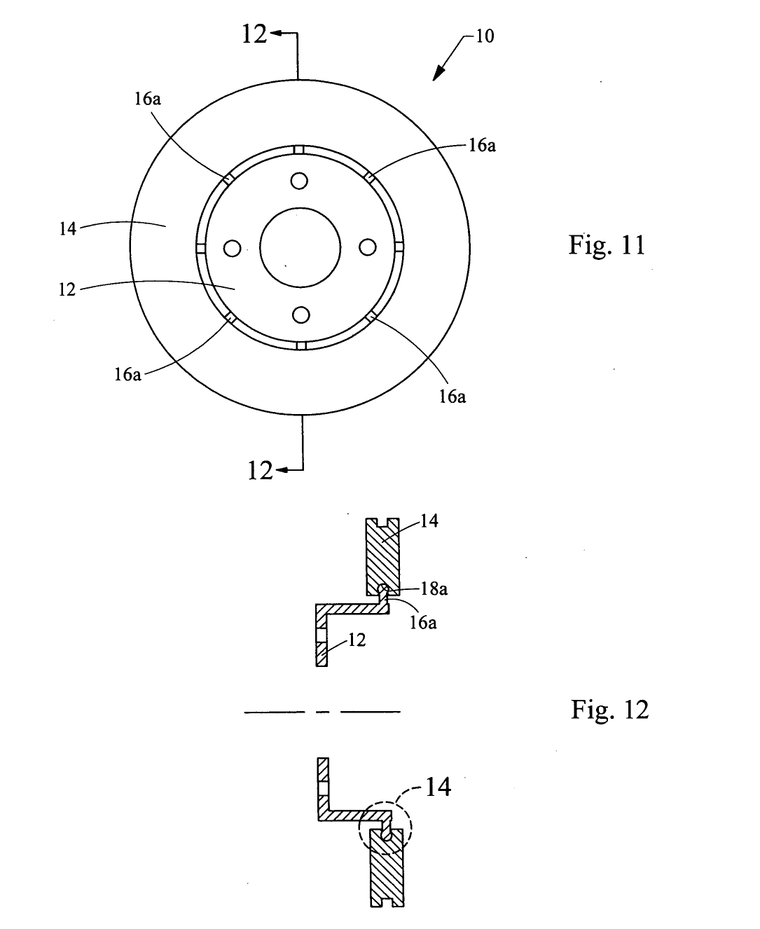

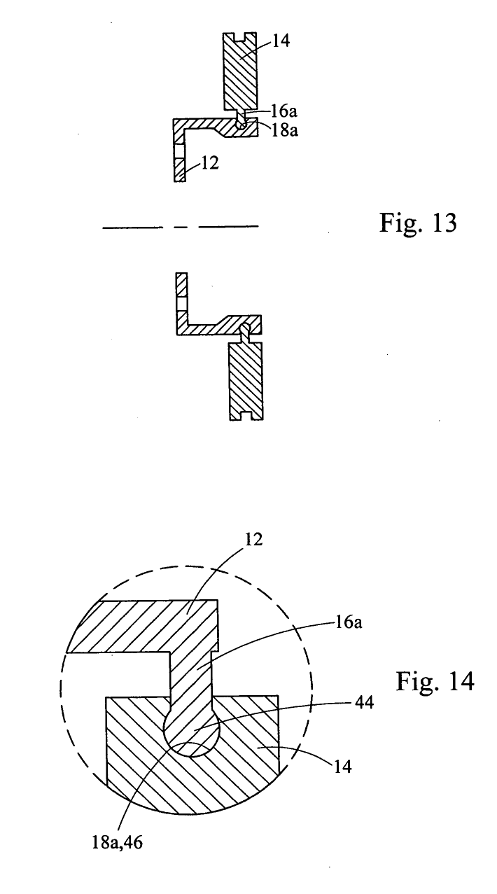

Referring to FIGS. 11-14, in yet another embodiment, the extending features 16a and the receiving features 18a define a ball stud engagement. In this embodiment, the extending features 16a have a ball or generally spherical shaped extension 44 formed at a distal end thereof, and the receiving features 18a define a correspondingly shaped pocket 46 to receive the ball 44 formed at the distal end of the extending features 18a, as shown in FIG. 14. This ball stud engagement allows rotational movement of the brake rotor portion 14 relative to the hub portion 12 about an axis normal to the plane defined by the cross sectional view shown in FIG. 14. The extending features 16a can extend from the hub portion 12 as shown in FIG. 12, or the extending features 16a can extend from the brake rotor portion 14, as shown in FIG. 13.

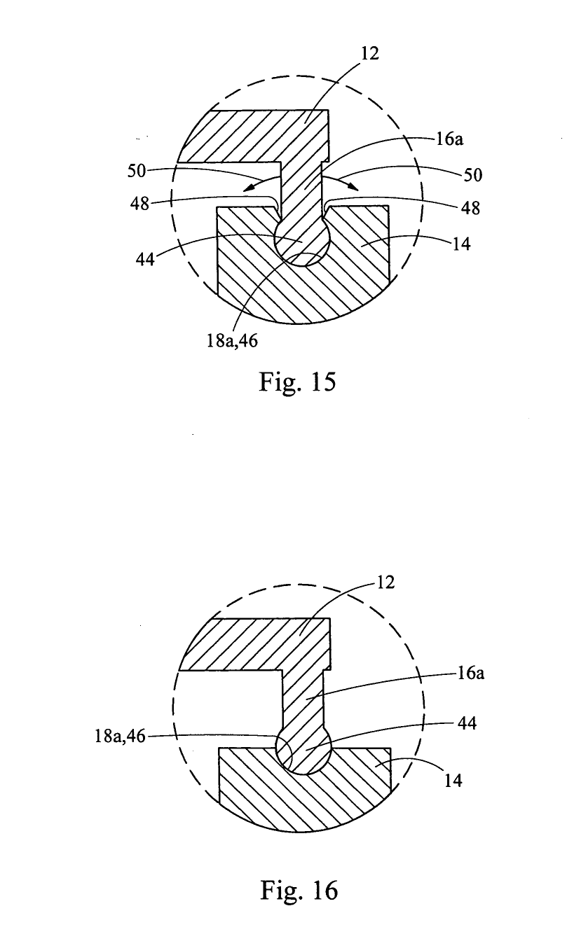

In an alternate embodiment, the pocket 46 of the receiving feature 18a includes a flared opening 48 to provide clearance to allow the extending portion 16a to rotate relative to the pocket 46, as indicated by arrows 50 in FIG. 15.

In still another variation of the ball stud engagement, the extending portion 16a is free to move radially with respect to the receiving portion 18a. There is no radial constraint between the ball 44 at the distal end of the extending portion 16a and the receiving portion 18a, as shown in FIG. 16. This radial clearance allows limited radial movement of the brake rotor portion 14 relative to the hub portion 12. This embodiment allows both limited radial movement and rotational movement of the brake rotor portion 14 relative to the hub portion 12.

The foregoing description of the embodiments described herein has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A two-piece brake rotor assembly comprising:
a hub portion and a brake rotor portion;
the brake rotor portion being mounted onto the hub portion;
one of the brake rotor portion and the hub portion including extending features and the other one of the brake rotor portion and the hub portion including receiving features, the extending features engaging the receiving features to secure the brake rotor portion onto the hub portion;
the engagement of the extending features and the receiving features being adapted to allow rotational movement of the rotor portion relative to the hub portion about a tangential axis at the engagement between the extending portions and receiving portions.

2. The brake rotor assembly of claim 1 wherein the extending features extend from the brake rotor portion and the receiving features are formed within the hub portion.

3. The brake rotor assembly of claim 2 wherein the extending features include an annular ridge extending radially inward from an inner diameter of the brake rotor portion and including circumferentially spaced radial discontinuities formed therein and the receiving features include an arnular channel formed within an outer diameter of the hub portion and including corresponding circumferentially spaced radial discontinuities that engage the discontinuities formed within the annular ridge.

4. The brake rotor assembly of claim 3 wherein the annular ridge includes axial indents spaced circumferentially thereon to mechanically interlock the brake rotor portion and the hub portion to prevent circumferential movement of the brake rotor portion relative to the hub portion.

5. The brake rotor assembly of claim 2 wherein he extending features include a plurality of spokes extending radially inward from an inner diameter of the brake rotor portion.

6. The brake rotor assembly of claim 5 wherein the receiving features include a plurality of pockets formed within an outer diameter of the hub, distal ends of one of the spokes being received within each of the pockets.

7. The brake rotor assembly of claim 1 wherein the extending features extend from the hub portion and the receiving features are formed within the brake rotor portion.

8. The brake rotor assembly of claim 7 wherein the extending features include an annular ridge extending radially inward from an inner diameter of the brake rotor portion and including circumferentially spaced radial discontinuities formed therein and the receiving features include an arnular channel formed within an outer diameter of the hub portion and including corresponding circumferentially spaced radial discontinuities that engage the discontinuities formed within the annular ridge.

9. The brake rotor assembly of claim 8 wherein the annular ridge includes axial indents spaced circumferentially thereon to mechanically interlock the brake rotor portion and the hub portion to prevent circumferential movement of the brake rotor portion relative to the hub portion.

10. The brake rotor assembly of claim 7 wherein the extending features include a plurality of spokes extending radially outward from an outer diameter of the hub portion.

11. The brake rotor assembly of claim 10 wherein the receiving features include a plurality of pockets formed within an inner diameter of the brake rotor portion, distal ends of one of the spokes being received within each of the pockets.

12. The brake rotor assembly of claim 1 wherein the extending features include a convex, arcuate shaped distal end and the receiving features include a concave arcuate shaped pocket, the extending features extending into the receiving features such that only the arcuate shaped distal end of the extending features extends within the arcuate shaped pocket, thereby allowing rotational movement of the extending features relative to the receiving features and therefore, allowing rotational movement of the hub portion relative to the brake rotor portion.

13. The brake rotor assembly of claim 1 wherein the extending features and the receiving features define a ball stud engagement, wherein the extending features have a ball formed at a distal end thereof and the receiving features define a corresponding pocket to receive the ball formed at the distal end of the extending features and allow rotational movement of the brake rotor portion relative to the hub portion.

14. The brake rotor assembly of claim 13 wherein the pocket of the receiving feature includes a flared opening to provide clearance to allow the extending portion to rotate relative to the pocket.

15. The brake rotor assembly of claim 1 wherein there is a radial degree of freedom between the extending features and the receiving features to allow limited radial movement of the brake rotor portion relative to the hub portion, thereby providing both limited radial movement and rotational movement of the brake rotor portion relative to the hub portion.
